(19) United States
(12) Patent Application Publication
(10) Pub. No.: US 2018/0150801 A1
(43) Pub. Date: May 31, 2018

(54) Selective Publication and/or Subscription of Information

(71) Applicant: Microsoft Technology Licensing, LLC, Redmond, WA (US)

(72) Inventor: Dhirendra Kumar Bhupati, Redmond, WA (US)

(73) Assignee: Microsoft Technology Licensing, LLC, Redmond, WA (US)

(21) Appl. No.: 15/361,650

(22) Filed: Nov. 28, 2016

(51) Int. Cl. G06Q 10/10; G06F 17/30

(52) U.S. Cl. CPC G06Q 10/109; G06F 17/30345

(57) ABSTRACT

Described herein is a system for communicating changed information. A first digital assistant component can identify and/or publish changed information of a user (e.g., contact information) to a changed information service system (e.g., cloud-based service). The changed information service system can publish the changed information to more subscriber(s). The subscriber(s) can utilize the changed information, for example, to communicate with the user that published the changed information.

### BACKGROUND

Information regarding a particular user (e.g., contact information) can change unpredictably. For example, a telephone number associated with a particular user can change based upon life events such as job change(s), geographical relocation(s) and the like. Having out-of-date information regarding a particular user can be frustrating for other(s) wanting to communicate with the particular user.

### SUMMARY

Described herein is a computing device comprising a processor and a memory, the memory comprising a first digital assistant component. The first digital assistant component can include a settings data store configured to store a setting associated with publication of changed information. The first digital assistant component can further include a publisher component configured to identify changed information about a user of the computing device and, based upon the setting stored in the settings data store, publish the identified changed information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for communicating changed information.

FIG. 2 is a functional block diagram that illustrates a first digital assistant component.

FIG. 3 is a functional block diagram that illustrates a changed information service system.

FIG. 4 is a functional block diagram that illustrates a second digital assistant component.

FIG. 5 illustrates an exemplary methodology of a method of communicating changed information.

FIG. 6 illustrates an exemplary methodology of a method of publishing changed information.

FIG. 7 illustrates an exemplary methodology of a method of subscribing to changed information.

FIG. 8 is a functional block diagram that illustrates an exemplary computing system.

### DETAILED DESCRIPTION

Various technologies pertaining to identification of, publication of and/or subscription to changed information regarding a particular user are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding identification of, publication of and/or subscription to changed information regarding a particular user. What follows are one or more exemplary systems and methods.

Aspects of the subject disclosure pertain to the technical problem of maintaining up-to-date information regarding a particular user. The technical features associated with addressing this problem involve identifying changed information regarding the particular user, selectively publishing the changed information and/or selectively subscribing to receiving the changed information. Accordingly, aspects of these technical features exhibit technical effects of more efficiently and effectively maintaining up-to-date information regarding the particular user.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

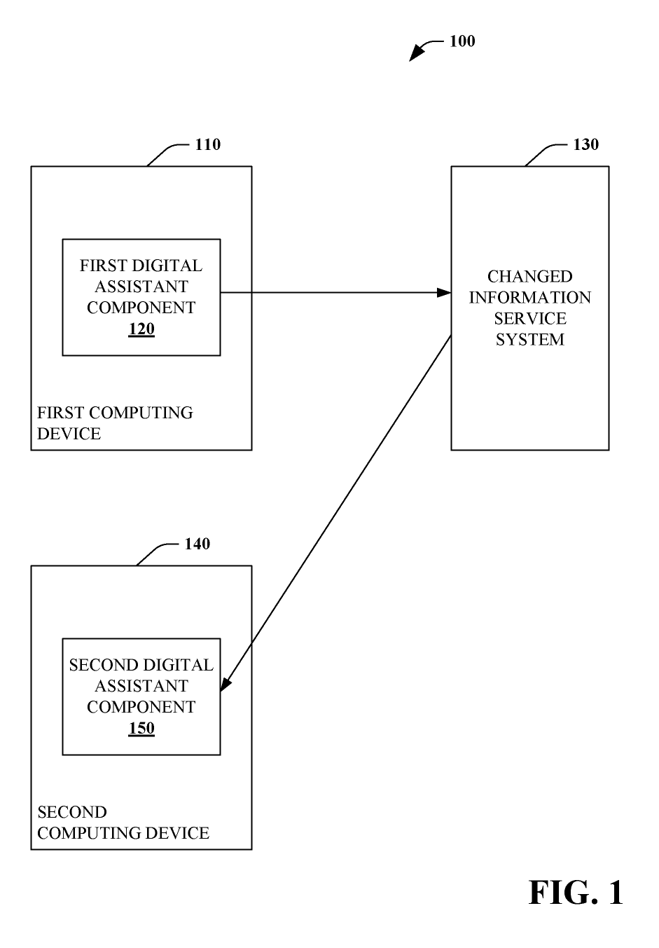

Referring to FIG. 1, a system for communicating changed information 100 is illustrated. The system 100 can include a first computing device 110 having a first digital assistant component 120 a changed information service system 130 and/or one or more second computing devices 140. The first computing device 110 can be communicatively coupled to the changed information service system 130. Further, the changed information service system 130 can be communicatively coupled to the one or more second computing devices 140 having a second digital assistant component 150.

In one embodiment, the first computing device 110 and/or the second computing devices 140 are communicatively coupled to the changed information service system 130 via the Internet (e.g., cloud-based changed information service system 130). In one embodiment, the first computing device 110 and/or the second computing devices 140 are communicatively coupled to the changed information service system 130 via a computer network.

The system 100 can facilitate communication of changed information about a user of the first computing device 100 to the changed information service system 130 and/or the one or more second computing devices 140. The changed information can comprise changes to any suitable information which a user of the first computing device 110 has selected to share with the changed information service system 130 and/or the one or more second computing devices 140. In one embodiment, the changed information comprises contact information associated with the user of the first computing device 110. For example, the contact information can comprise a full name, a company name, a job title, a web address, an instant messaging address, a business telephone number, a home telephone number, a facsimile number, a mobile telephone number, a business address, a home address and/or an email address, etc. of the user of the first computing device 110.

In one embodiment, in order to prevent personally identifiable information from being transmitted from the first computing device 110, the user of the first computing device 110 can opt-in to sharing of one or more particular items of contact information with the changed information service system 130. For example, the user of the first computing device 110 can selectively choose to permit only changes to the user's mobile telephone number and/or email address(es) to be transmitted to the changed information service system 130.

In one embodiment, in order to prevent personally identifiable information from being transmitted without restriction, the user of the first computing device 110 can opt-in to allowing one or more particular items of contact information to be provided to one or more particular users of the one or more second computing devices 140. For example, the user of the first computing device 110 can selectively choose to only permit changes to be published to “Userl” of one or more second computing devices 140.

In one embodiment, the user of the first computing device 110 can opt-in to allowing one or more particular items of contact information to be provided to users identified in an electronically stored address book of the user of the first computing device 110. For example, the user of the first computing device 110 can selectively choose to permit changes to be published to user(s) identified in the electronically stored address book of the user of the first computing device 110.

In one embodiment, the user of the first computing device 110 can identify one or more users of the second computing devices 140 to block from receiving changed information. For example, the user of the first computing device 110 can selectively choose to block changes from being published to particular user(s) of the one or more second computing devices 140.

The first digital assistant component 120 provides assistance to a user of the first computing device 110. In one embodiment, the first digital assistant component 120 runs as a background task of the first computing device 110. In one embodiment, the first digital assistant component 120 runs in response to a user of the first computing device 110 selecting to run the first digital assistant component 120.

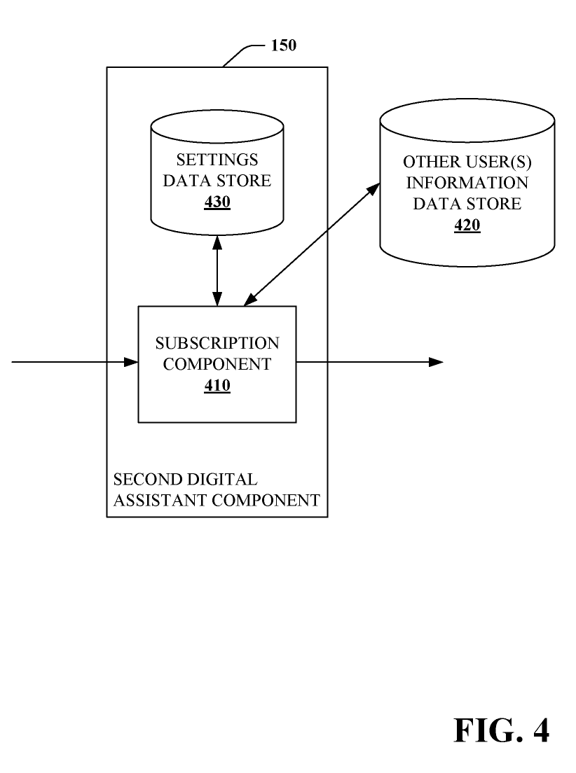

The second digital assistant component 150 provides assistance to a user of the one or more second computing devices 140. The second digital assistant component 150 can receive changed information from the changed information service system 130, as described more fully below with the discussion of FIG. 4.

In one embodiment, the second digital assistant component 150 runs as a background task of the one or more second computing devices 140. In one embodiment, the second digital assistant component 150 runs in response to a user of the second computing device 140 selecting to run the second digital assistant component 150.

In one embodiment, the first digital assistant component 120 and/or the second digital assistant component 120 are voice-activated, for example, from a user requesting assistance. In one embodiment, the first digital assistant component 120 and/or the second digital assistant component 120 receive text-based information, for example, from a user requesting assistance. In one embodiment, the first digital assistant component 120 and/or the second digital assistant component 120 receive voice-based information, for example, from a user requesting assistance.

In one embodiment, the first digital assistant component 120 and the second digital assistant component 150 are on the same computing system (e.g., first computing device 110 and second computing devices 140 are the same physical and/or logical device). In one embodiment, the first digital assistant component 120 and the second digital assistant component 150 are on physically different computing systems (e.g., first computing device 110 and second computing devices 140 are different devices).

The first digital assistant component 120 can identify and/or publish changed information to the changed information service system 130, as described more fully below.

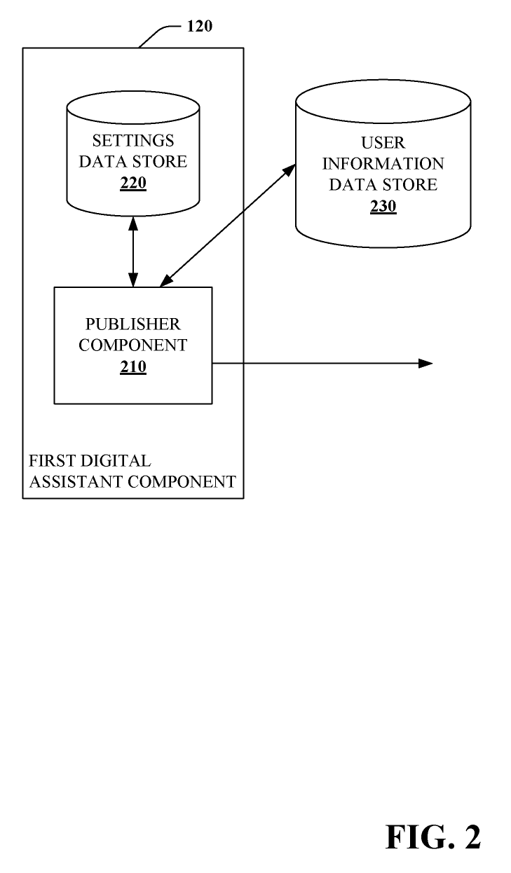

Turning to FIG. 2, the first digital assistant component 120 includes a publisher component 210 that publishes changed information about a user of the first computing device 100. The first digital assistant component 120 can further include a settings data store 220 that stores setting(s) associated with publication of the changed information.

In one embodiment, the stored setting(s) can include the user's selection of particular item(s) of changed information to be published (e.g., publish changed email address). In one embodiment, the stored setting(s) can include the user's selection of particular item(s) of changed information that are not to be published (e.g., do not publish changed mobile telephone number).

In one embodiment, the stored setting(s) can include the user's selection of particular user(s) (e.g., individual user(s) and/or group(s) of user(s)) to whom changed information is permitted to be published (e.g., “User1” is permitted to receive changed information). In one embodiment, the stored setting(s) can include the user's selection of particular user(s) to whom changed information is not permitted to be published (e.g., “User2” is not permitted to receive changed information).

In one embodiment, the stored setting(s) can include setting(s) (e.g., information) regarding when changed information is to be communicated to the changed information service system 130 and/or published by the changed information service system 130 to the one or more second computing devices 140. For example, the setting(s) regarding when changed information is to be communicated and/or published can be temporal (e.g., specific time of day/week, hourly, daily, weekly, etc.). In one embodiment, the setting(s) regarding when changed information is to be communicated and/or published can be event-based (e.g., publish changed information responsive to changing of information). In one embodiment, the setting(s) regarding when changed information is to be communicated and/or published can be based upon characteristic(s) associated with the first computing device 110. For example, with respect to the first computing device 110, the setting(s) can be based upon below a specified percentage of processing power utilization, when the user of the first computing device 110 is determined to not be present or using the first computing device 110 for a predetermined period of time, when the first computing device 110 is utilizing Wi-Fi, when the first computing device 110 is utilizing a wired local area network (LAN), when the first computing device 110 is utilizing a cellular data connection, etc.

Based upon the setting(s) stored in the settings data store 220, the publisher component 210 can identify changed information stored in a user information data store 230 to communicate to the changed information service system 130. In one embodiment, the user information data store 230 can comprise database(s) or other suitable data structure(s) to facilitate selective identification and retrieval of changed information of the user. In one embodiment, the first digital assistant component 120 can comprise the user information data store 230.

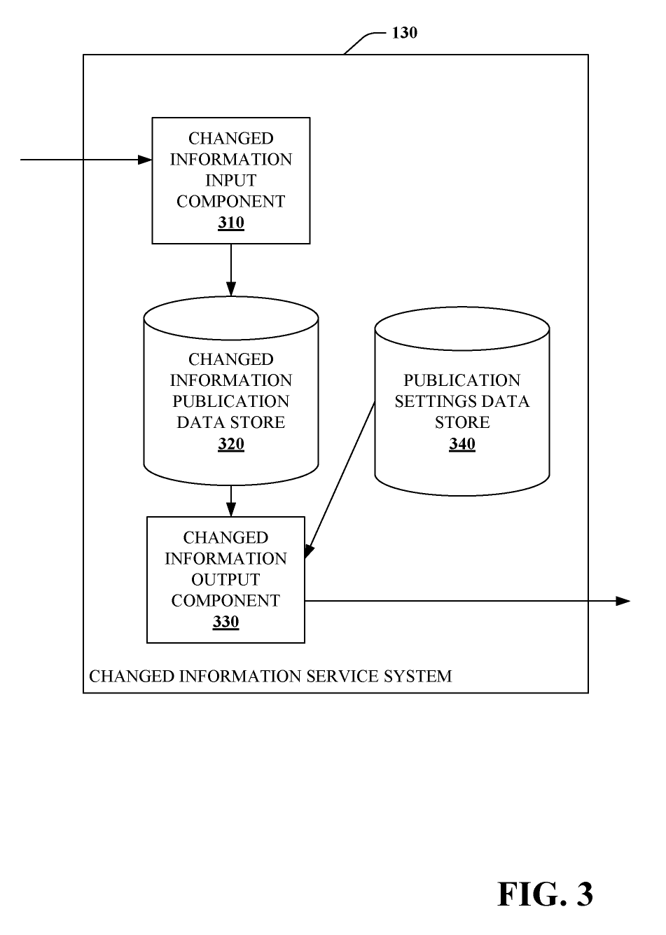

Referring next to FIG. 3, the changed information service system 130 can include a changed information input component 310 that receives changed information, for example, from the first digital assistant component 120 of the first computing device 110. The changed information input component 310 can store the received changed information in a changed information publication store 320. The changed information publication store 320 can comprise database(s) or other suitable data structure(s) to facilitate storage, selective identification and/or retrieval of changed information. In one embodiment, the changed information input component 310 can notify a changed information output component 330 of receipt of the changed information stored in the changed information publication store 320.

The changed information output component 310 can publish the changed information, for example, to the one or more second digital assistant components 150. In one embodiment, the changed information output component 310 can determine when to publish the changed information based upon setting(s) stored in a publication settings data store 340. In one embodiment, the stored setting(s) can comprise setting(s) of a publisher of the changed information (e.g., upon receipt and/or periodic update). In one embodiment, the stored setting(s) can comprise setting(s) of a subscriber to the changed information (e.g., upon receipt and/or periodic update).

Based upon the setting(s) in the publication settings data store 340, the changed information output component 310 can provide the changed information to one or more subscriber(s) (e.g., second digital assistant components 150). In one embodiment, the changed information output component 310 can determine to whom to publish the changed information based upon setting(s) stored in the publication settings data store 340. In one embodiment, the stored setting(s) can comprise setting(s) of a publisher of the changed information (e.g., particular user(s) permitted or blocked from receiving changed information). In one embodiment, the stored setting(s) can comprise setting(s) of a subscriber of the changed information (e.g., changed information of particular user(s) permitted or blocked by the subscriber). In one embodiment, the changed information output component 330 determines (e.g., matches) changed information of a particular user of which another particular user has subscribed (e.g., and is permitted to receive by the particular user).

Turning next to FIG. 4, the second digital assistant component 150 can include a subscription component 410 that receives changed information associated with a particular user and stores the changed information in an other users information data store 420. In one embodiment, the changed information is provided to a user of the second digital assistant component 150 without input of the user of the second digital assistant component 150. In one embodiment, the user of the second digital assistant component 150 is notified of the changed information; however, the changed information is not utilized without the express consent of the user of the second digital assistant component 150. For example, when sending an email to “User1”, the user of the second digital assistant component 150 can be notified that the email address has changed from a first email address to a second email address. However, the decision to utilize the changed information (e.g., second email address instead of the first email address) is left to the user of the second digital assistant component 150. The changed information can be utilized to communicate with another user.

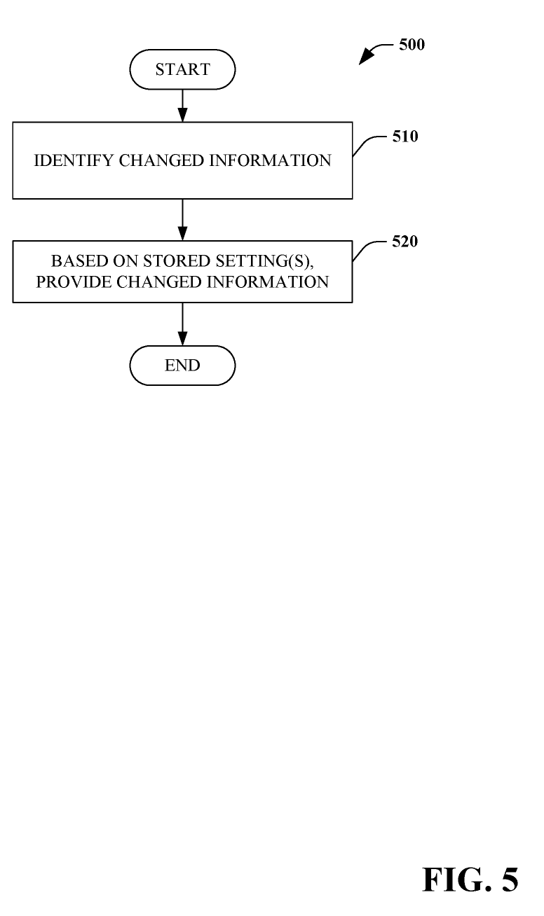

FIGS. 5-7 illustrate exemplary methodologies relating to communicating changed information. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 5, a method of communicating changed information 500 is illustrated. At 510, changed information associated is identified. For example, the changed information can be associated with a user of the first computing device 110, as discussed above. In one embodiment, the changed information comprises contact information which can include a full name, a company name, a job title, a web address, an instant messaging address, a business telephone number, a home telephone number, a facsimile number, a mobile telephone number, a business address, a home address and/or an email address, etc. of the user of the first computing device 110.

At 520, based upon stored setting(s), the identified changed information is provided, for example, to a changed information service system 130. In one embodiment, the user of the first computing device 110 can selectively identify one or more particular items of changed item(s) of changed information to communicate to the changed information service system 130. In one embodiment, the user of the first computing device 110 can selectively identify one or more particular users of the second computing device 150 to which the changed information service system 130 can publish the changed information.

In one embodiment, in addition to communicating the changed information to the changed information service system 130, information regarding one or more users to be permitted to receive the changed information and/or one or more users to be blocked from receiving the changed information can be provided, for example, by the first digital assistant component 120 to the changed information service system 130. In one embodiment, information regarding one or more users to be permitted to receive the changed information and/or one or more users to be blocked from receiving the changed information is stored in the publication settings data store 340 and utilized by the changed information output component 330 when identifying user(s) to receive the changed information.

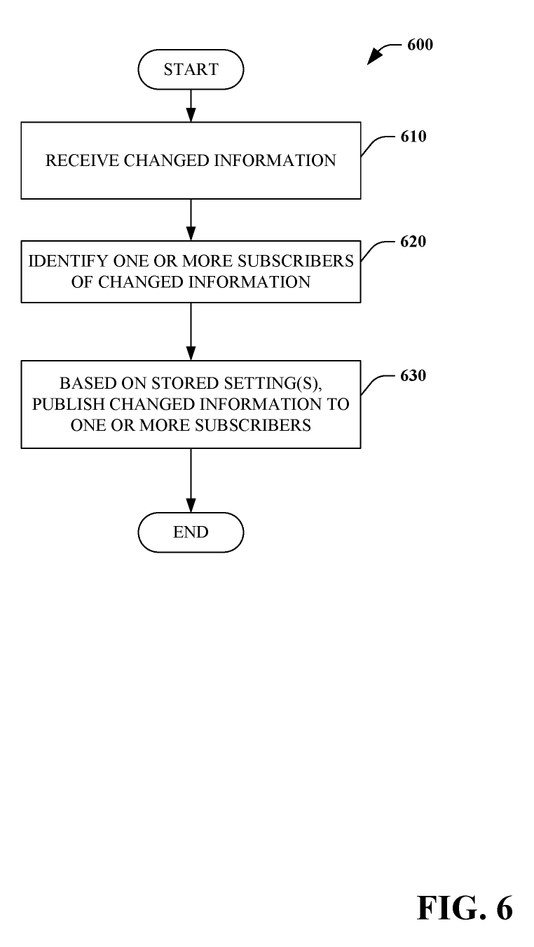

Next, turning to FIG. 6, a method of publishing changed information 600 is illustrated. At 610, changed information is received, for example, by the changed information input component 310 from the first digital assistant component 120. In one embodiment, the changed information comprises one or more items of contact information of a user of the first digital assistant component 120. In one embodiment, information regarding one or more users to be permitted to receive the changed information and/or one or more users to be blocked from receiving the changed information is also received, for example, from the first digital assistant component 120.

At 620, one or more subscribers of the changed information are identified. In one embodiment, identification is based upon setting(s) stored in a publication settings data store 340. In one embodiment, identification is based upon information received, for example, from the first digital assistant component 120.

At 630, based upon stored setting(s), the received changed information is provided to one or more subscribers. In one embodiment, the stored setting(s) can comprise setting(s) of a publisher of the changed information (e.g., upon receipt and/or periodic update). In one embodiment, the stored setting(s) can comprise setting(s) of a subscriber to the changed information (e.g., upon receipt and/or periodic update).

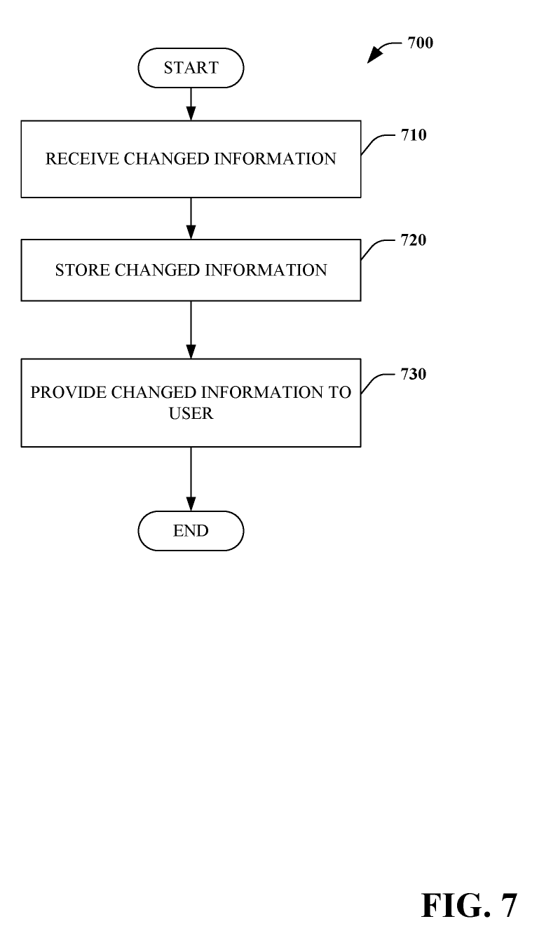

Turning to FIG. 7, a method of subscribing to changed information 700 is illustrated. At 710, changed information is received, for example, by the second digital assistant component 150 from the changed information service system 130. At 720, the changed information is stored, for example, in the other user(s) information data store 420. At 730, the changed information is provided to a user, for example, by the second digital assistant component 150.

Described herein is a computing device, comprising a processor and a memory. The memory can comprise a first digital assistant component can include a settings data store configured to store a setting associated with publication of changed information. The first digital assistant component can further include a publisher component configured to identify changed information about a user of the computing device and based upon the setting stored in the settings data store, publish the identified changed information.

The computing device can include wherein the first digital assistant component is configured to provide assistance to the user of the computing device. The computing device can further include wherein the first digital assistant component is configured to receive voice-based information from the user. The computing device can include wherein the first digital assistant component is configured to receive text-based information from the user.

The computing device can include wherein the identified changed information is provided to a changed information service system via a computer network. The computing device can further include wherein the stored setting comprises a selection of a particular user to whom the identified changed information is permitted to be published. The computing device can include wherein the stored setting comprises a selection of a particular user to whom the identified changed information is not permitted to be published.

The computing device can include wherein the stored setting comprises information regarding when the identified changed information is to be published. The computing device can further include wherein the stored setting comprises information regarding when the identified changed information is to be published based upon a characteristic associated with the computing device.

The computing device can include wherein the changed information comprises contact information. The computing device can further include wherein the contact information comprises at least one of a full name, a company name, a job title, a web address, an instant messaging address, a business telephone number, a home telephone number, a facsimile number, a mobile telephone number, a business address, a home address or an email address of the user of the computing device.

Described herein is a method of communicating changed information, comprising by a first digital assistant component, identifying changed information; and based upon a stored setting, providing the changed information to a changed information service system. The method can include wherein the first digital assistant component is configured to provide assistance to a user of a computing device.

The method can include wherein the stored setting comprises a selection of a particular user to whom the identified changed information is permitted to be published. The method can further include wherein the identified changed information comprises at least one of a full name, a company name, a job title, a web address, an instant messaging address, a business telephone number, a home telephone number, a facsimile number, a mobile telephone number, a business address, a home address or an email address of the user of the computing device.

Described herein is a method of subscribing to changed information, comprising receiving changed information; storing the received changed information; and providing the received changed information to a user. The method can include wherein the changed information is provided to the user by a digital assistant component.

The method can include wherein the changed information is provided to the user without input of the user. The method can further include wherein the changed information is not utilized without express consent of the user. The method can include utilizing the changed information to communicate with another user.

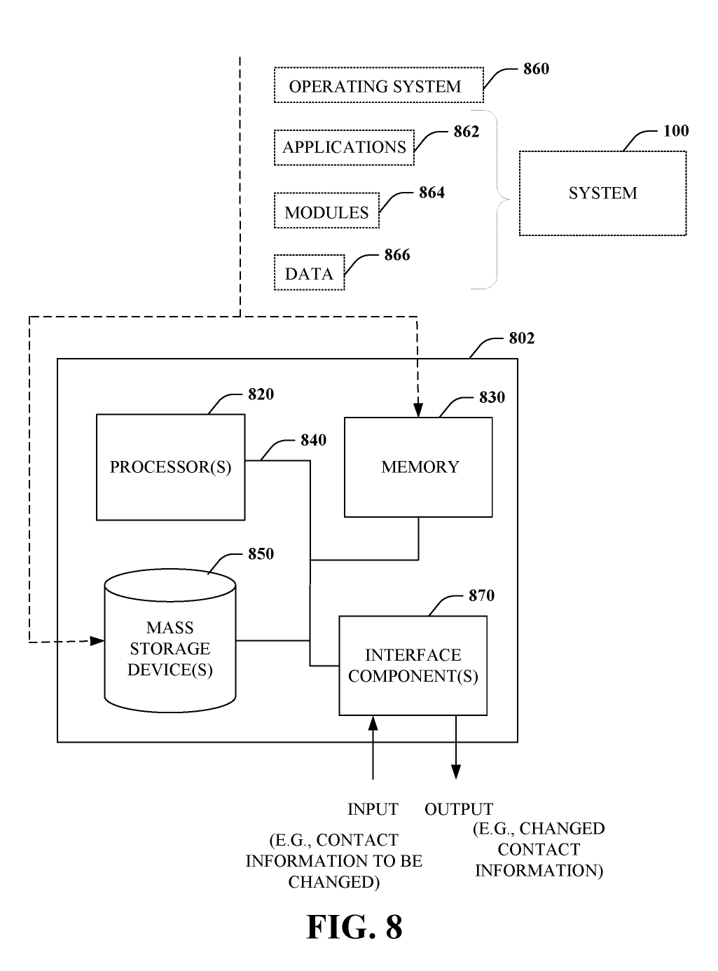

With reference to FIG. 8, illustrated is an example general-purpose computer or computing device 802 (e.g., mobile phone, desktop, laptop, tablet, watch, server, hand-held, programmable consumer or industrial electronics, set-top box, game system, compute node, etc.). For instance, the computing device 802 may be used in a system for communicating changed information 100.

The computer 802 includes one or more processor(s) 820, memory 830, system bus 840, mass storage device(s) 850, and one or more interface components 870. The system bus 840 communicatively couples at least the above system constituents. However, it is to be appreciated that in its simplest form the computer 802 can include one or more processors 820 coupled to memory 830 that execute various computer executable actions, instructions, and or components stored in memory 830. The instructions may be, for instance, instructions for implementing functionality described as being carried out by one or more components discussed above or instructions for implementing one or more of the methods described above.

The processor(s) 820 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 820 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 820 can be a graphics processor.

The computer 802 can include or otherwise interact with a variety of computer-readable media to facilitate control of the computer 802 to implement one or more aspects of the claimed subject matter. The computer-readable media can be any available media that can be accessed by the computer 802 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 802. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 830 and mass storage device(s) 850 are examples of computer-readable storage media. Depending on the exact configuration and type of computing device, memory 830 may be volatile (e.g., RAM), non-volatile (e.g., ROM, flash memory, etc.) or some combination of the two. By way of example, the basic input/output system (BIOS), including basic routines to transfer information between elements within the computer 802, such as during start-up, can be stored in nonvolatile memory, while volatile memory can act as external cache memory to facilitate processing by the processor(s) 820, among other things.

Mass storage device(s) 850 includes removable/non-removable, volatile/non-volatile computer storage media for storage of large amounts of data relative to the memory 830. For example, mass storage device(s) 850 includes, but is not limited to, one or more devices such as a magnetic or optical disk drive, floppy disk drive, flash memory, solid-state drive, or memory stick.

Memory 830 and mass storage device(s) 850 can include, or have stored therein, operating system 860, one or more applications 862, one or more program modules 864, and data 866. The operating system 860 acts to control and allocate resources of the computer 802. Applications 862 include one or both of system and application software and can exploit management of resources by the operating system 860 through program modules 864 and data 866 stored in memory 830 and/or mass storage device (s) 850 to perform one or more actions. Accordingly, applications 862 can turn a general-purpose computer 802 into a specialized machine in accordance with the logic provided thereby. In one example, application 862 includes key service component 160.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 862, and include one or more modules 864 and data 866 stored in memory and/or mass storage device(s) 850 whose functionality can be realized when executed by one or more processor(s) 820.

In accordance with one particular embodiment, the processor(s) 820 can correspond to a system on a chip (SOC) or like architecture including, or in other words integrating, both hardware and software on a single integrated circuit substrate. Here, the processor(s) 820 can include one or more processors as well as memory at least similar to processor(s) 820 and memory 830, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 802 also includes one or more interface components 870 that are communicatively coupled to the system bus 840 and facilitate interaction with the computer 802. By way of example, the interface component 870 can be a port (e.g., serial, parallel, PCMCIA, USB, FireWire, etc.) or an interface card (e.g., sound, video, etc.) or the like. In one example implementation, the interface component 870 can be embodied as a user input/output interface to enable a user to enter commands and information into the computer 802, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 870 can be embodied as an output peripheral interface to supply output to displays (e.g., LCD, LED, plasma, etc.), speakers, printers, and/or other computers, among other things. Still further yet, the interface component 870 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A computing device, comprising:
a processor and a memory, the memory comprising:
a first digital assistant component comprising:
a settings data store configured to store a setting associated with publication of changed information; and
a publisher component configured to identify changed information about a user of the computing device and based upon the setting stored in the settings data store, publish the identified changed information.

2. The computing device of claim 1, wherein the first digital assistant component is configured to provide assistance to the user of the computing device.

3. The computing device of claim 2, wherein the first digital assistant component is configured to receive voice-based information from the user.

4. The computing device of claim 2, wherein the first digital assistant component is configured to receive text-based information from the user.

5. The computing device of claim 1, wherein the identified changed information is provided to a changed information service system via a computer network.

6. The computing device of claim 1, wherein the stored setting comprises a selection of a particular user to whom the identified changed information is permitted to be published.

7. The computing device of claim 1, wherein the stored setting comprises a selection of a particular user to whom the identified changed information is not permitted to be published.

8. The computing device of claim 1, wherein the stored setting comprises information regarding when the identified changed information is to be published.

9. The computing device of claim 1, wherein the stored setting comprises information regarding when the identified changed information is to be published based upon a characteristic associated with the computing device.

10. The computing device of claim 1, wherein the changed information comprises contact information.

11. The computing device of claim 10, wherein the contact information comprises at least one of a full name, a company name, a job title, a web address, an instant messaging address, a business telephone number, a home telephone number, a facsimile number, a mobile telephone number, a business address, a home address or an email address of the user of the computing device.

12. A method of communicating changed information, comprising:
by a first digital assistant component, identifying changed information; and
based upon a stored setting, providing the changed information to a changed information service system.

13. The method of claim 12, wherein the first digital assistant component is configured to provide assistance to a user of a computing device.

14. The method claim 12, wherein the stored setting comprises a selection of a particular user to whom the identified changed information is permitted to be published.

15. The method of claim 12, wherein the identified changed information comprises at least one of a full name, a company name, a job title, a web address, an instant messaging address, a business telephone number, a home telephone number, a facsimile number, a mobile telephone number, a business address, a home address or an email address of the user of the computing device.

16. A method of subscribing to changed information, comprising:
receiving changed information;
storing the received changed information; and
providing the received changed information to a user.

17. The method of claim 16, wherein the changed information is provided to the user by a digital assistant component.

18. The method of claim 16, wherein the changed information is provided to the user without input of the user.

19. The method of claim 16, wherein the changed information is not utilized without express consent of the user.

20. The method of claim 16, utilizing the changed information to communicate with another user.
